(19) United States
(12) Patent Application Publication
(10) Pub. No.: US 2025/0112678 A1
(43) Pub. Date: Apr. 3, 2025

(54) SYSTEM AND METHOD FOR CONTROLLING SOUNDING OR BEAMFORMING

(71) Applicant: Samsung Electronics Co., Ltd., Suwon-si (KR)

(72) Inventors: Ravi GIDVANI, Fremont, CA (US); Eunsung JEON, Hwaseong-si (KR); Mark RISON, Cambridge (GB); Michail KOUNDOURAKIS, Hamburg (DE); Myeongjin KIM, Hwaseong-si (KR); Jung Woon LEE, Daejeon (KR); Hunmin SHIN, Hwaseong-si (KR); Chulho CHUNG, Yongin-si (KR)

(21) Appl. No.: 18/599,184

(22) Filed: Mar. 7, 2024

Related U.S. Application Data
(60) Provisional application No. 63/541,629, filed on Sep. 29, 2023.

(51) Int. Cl. H04B 7/06

(52) U.S. Cl. CPC H04B 7/0617

(57) ABSTRACT

A system and a method are disclosed for controlling sounding or beamforming. In some embodiments, the method includes transmitting, by a first station, an instruction to a second station, the second station being a beamforming station, wherein the instruction instructs the second station: to disable or enable beamforming, or to disable or enable sounding.

### CROSS-REFERENCE TO RELATED APPLICATION

This application claims the priority benefit under 35 U.S.C. § 119(e) of U.S. Provisional Application No. 63/541,629, filed on Sep. 29, 2023, the disclosure of which is incorporated by reference in its entirety as if fully set forth herein.

### TECHNICAL FIELD

The disclosure generally relates to wireless communications. More particularly, the subject matter disclosed herein relates to improvements to the control of sounding or beamforming in a system for wireless communications.

### SUMMARY

Wireless devices may communicate by sending wireless transmission to each other using omnidirectional beams. Such beams may have the advantage of being effective for a large range of relative locations of the communicating devices, but the achievable signal to noise ratio may be relatively low.

To solve this problem, a directional beam may be transmitted by one of the devices (or respective directional beams may be transmitted by both of the devices) to achieve a significantly higher signal to noise ratio. Sounding may be employed by the transmitting device to determine parameters to be used for transmit beam forming.

One issue with the above approach is that sounding may incur significant overhead cost (e.g., a loss of throughput) which in some circumstances may not be justified.

To overcome these issues, systems and methods are described herein for disabling, by a receiving device (which receives a beam from a beamforming device), sounding, or beamforming, or both.

The above approaches improve on previous methods because in circumstances in which the overhead cost of sounding is not justified for a receiving device, it may avoid such overhead by instructing the beamforming device to disable sounding or beamforming, or both.

According to an embodiment of the present disclosure, there is provided a method, including: transmitting, by a first station, an instruction to a second station, the second station being a beamforming station, wherein the instruction instructs the second station: to disable or enable beamforming, or to enable or disable sounding.

In some embodiments, the instruction instructs the second station to disable sounding.

In some embodiments, the instruction further instructs the second station to disable beamforming.

In some embodiments, the first station is a non-access-point station. In some embodiments: the instruction includes two bits; and the two bits are configured to indicate one of three states, the three states including: a first state in which beamforming and sounding are both enabled, a second state in which beamforming is enabled and sounding is disabled, and a third state in which beamforming and sounding are both disabled.

In some embodiments, the instruction includes a bit, and the bit is in a management frame.

In some embodiments, the bit is in an Operating Mode Indication field.

In some embodiments, the bit is in an Operating Mode Notification Action frame.

In some embodiments, the bit is in a new Action frame or in a new Operating Mode Indication frame.

In some embodiments, the instruction includes a bit, and the bit is in control information of a frame.

In some embodiments, the frame is a management frame.

In some embodiments, the frame is a data frame.

In some embodiments, the frame is part of an Operating Mode Indication.

In some embodiments, the method further includes receiving, by the first station, from the second station, a capability signaling message, the capability signaling message indicating that the second station is capable of following an instruction: to disable or enable beamforming, or to disable or enable sounding.

In some embodiments, the capability signaling message is a physical layer capability signaling message.

In some embodiments, the capability signaling message is a portion of a management frame.

According to an embodiment of the present disclosure, there is provided a device, including: a radio; one or more processors; and a memory storing instructions which, when executed by the one or more processors, cause performance of transmitting, by the radio, an instruction to a first station, the first station being a beamforming station, wherein the instruction instructs the first station: to disable or enable beamforming, or to disable or enable sounding.

In some embodiments, the instruction instructs the first station to disable sounding.

In some embodiments, the device includes a non-Access Point Station.

According to an embodiment of the present disclosure, there is provided a device, including: a radio; means for processing; and a memory storing instructions which, when executed by the means for processing, cause performance of transmitting, by the radio, an instruction to a first station, the first station being a beamforming station, wherein the instruction instructs the first station: to disable or enable beamforming, or to disable or enable sounding.

### BRIEF DESCRIPTION OF THE DRAWINGS

In the following section, the aspects of the subject matter disclosed herein will be described with reference to exemplary embodiments illustrated in the figures, in which:

FIG. 1 is a block diagram of two devices in wireless communication, according to an embodiment.

FIG. 2 is a table showing a mapping of three-bit numbers to corresponding states, according to an embodiment.

FIG. 3 is a flow chart of a method, according to an embodiment.

FIG. 4 is a block diagram of an electronic device in a network environment, according to an embodiment.

FIG. 5 shows a system including a User Equipment (UE) and a network node (gNB) in communication with each other, according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and case of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

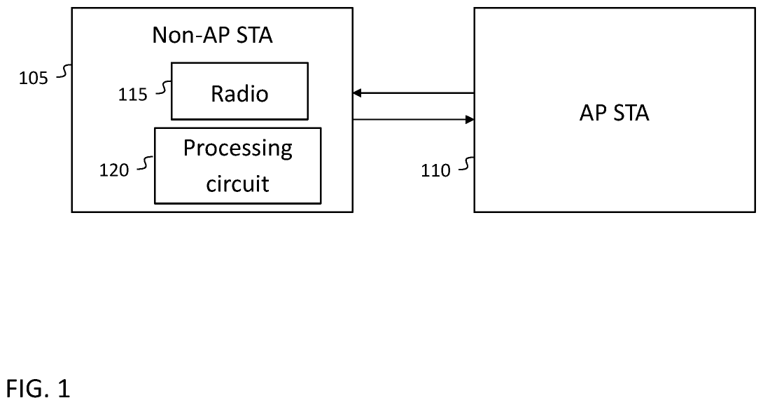

In a wireless communication system, such as a Wi-Fi system that complies with one of the 802.11 standards promulgated by the Institute of Electrical and Electronics Engineers (IEEE), data may be exchanged between a non-Access Point Station (non-AP STA) 105 and an Access Point Station (AP STA) 110 as illustrated in FIG. 1. The exchanges of data may occur through wireless transmissions made by the non-Access Point Station 105 or by the Access Point Station 110. The non-Access Point Station 105 may include a radio 115 and a processing circuit 120. The processing circuit 120 may perform one or more of the methods described herein, e.g., transmitting an instruction through the radio 115.

Such transmissions may be substantially omnidirectional (using transmitting beams that have little gain or directivity) or they may be made using directional beams having relatively high gain. When a directional beam is employed, it may be advantageous to aim such a beam (e.g., using suitable coefficients in a phased array antenna) so that the receiving antenna receives a relatively high signal level (e.g., by aiming the beam at the receiving antenna). The process of shaping the transmitted beam so as to achieve an acceptable signal level at a receiver may be referred to as beamforming. The station (e.g., the non-Access Point Station 105 or the Access Point Station 110) that performs the beamforming of a transmitted beam may be referred to as the beamformer, or the “beamforming station”, and the station (e.g., the non-Access Point Station 105 or the Access Point Station 110) that receives the transmitted beam may be referred to as a the beamformee.

The selection of parameters (e.g., of coefficients for use in a phased array antenna) for beamforming may be made using channel calibration procedures which may be referred to as channel sounding. The concept of beamforming was first introduced in 802.11 n. Beamforming includes two parts: sounding and beamforming. During sounding, the beamformer exchanges a frame sequence with the beamformee to collect a compressed beamforming report (CBR) from the beamformee.

During beamforming, once the channel information (e.g., channel information contained in the compressed beamforming report) is available from one more beamformees (e.g., from one or more non-Access Point Stations 105), the beamformer (e.g., the Access Point Station 110) may use the channel information to direct beamformed physical layer protocol data units (PPDUs) toward the one or more beamformees.

The use of a sounding sequence may carry a cost in that it may introduce overhead. In some circumstances, this cost may be outweighed by the benefit of the ability to use a higher data rate modulation and coding scheme (MCS), as a result of an improvement in signal to noise ratio that may be achieved using beamforming. The 802.11 standards do not mandate nor recommend the periodicity of the sounding sequence; the beamformer may initiate the sounding sequence at different intervals depending on its implementation.

Certain beamformer implementations may initiate sounding sequences sufficiently frequently that the resulting overhead significantly degrades the data throughput. Such a high frequency of sounding sequences may be a result of unintentional algorithmic behavior, corner conditions or interoperability issues. Moreover, in some circumstances, after successful sounding, the beamformee may be unable to receive beamformed physical layer protocol data units successfully. In such circumstances it may be advantageous for the beamformee to operate without beamforming or without sounding.

Other circumstances may exist in which it may be advantageous for the beamformee to operate without beamforming or without sounding, potentially at the cost of lower throughput. For example, the internal state of the beamformee may be one in which, for power saving or memory limitations, the beamformee may temporarily want to opt out of beam forming in exchange for lower throughput.

When such conditions are detected, the beamformer may have the option, under the 802.11 standard, of excluding the beamformee from the beamforming sequence completely. The beamformee, however, has no such option to temporarily disable sounding, and, even when it would be advantageous for the beamformee to operate without beamforming or without sounding the beamformee may continue to be burdened with the overhead and reduced throughput of sounding.

As such, in some embodiments, a mechanism is provided by which the beamformee (which may be referred to as a first station, and which may be a non-Access Point Station 105 or an Access Point Station 110) may disable sounding temporarily, by transmitting a suitable instructions, to a beamformer (which may be referred to as a second station, and which may be a non-Access Point Station 105 or an Access Point Station 110). The instruction may instruct the second station to disable or enable beamforming, or to enable or disable sounding.

In some embodiments, the instruction includes a single bit, that informs the beamformer that the beamformee is opting into (or opting out of) beamforming entirely (i.e., the beamformee is opting out of both sounding and beamforming), and, accordingly, the instruction instructs the beamformer either (i) to perform beamforming and sounding or (ii) to perform neither sounding nor beamforming. In such an embodiment, capability signaling may be used by the beamformer, as discussed in further detail below. The bit may be coded either way (e.g., either (i) a value of one may indicate that beamforming and sounding are to be performed, and a value of zero may indicate that neither beamforming nor sounding are to be performed, or (ii) a value of zero may indicate that beamforming and sounding are to be performed, and a value of one may indicate that neither beamforming nor sounding are to be performed). The bit may be part of an Operating Mode Indication (OMI) or any signaling frame that is indicated to beamformer.

In some embodiments, the instruction includes two bits configured to indicate one of three states, the three states including (i) a first state in which beamforming and sounding are both enabled, (ii) a second state in which beamforming is enabled and sounding is disabled, and (iii) a third state in which beamforming and sounding are both disabled. In such an embodiment, capability signaling may be used by the beamformer, as discussed in further detail below. In a state in which beamforming is enabled and sounding is disabled, beamforming may be performed by the beamformer using implicit Channel State Information (CSI) or Channel State Information that was obtained at some time in the past. The Channel State Information that was obtained at some time in the past (i) may have been obtained (e.g., using sounding) sufficiently recently that it may still be considered reliable, or (ii) the Channel State Information may have been obtained (e.g., using sounding) at a point in time that is sufficiently far in the past that the Channel State Information is not likely to remain reliable (e.g., it may be “stale”); in the latter case, such stale Channel State Information may nonetheless be employed if it is expected to result in beamforming that, while not optimal, results in a better signal to noise ratio than not using beamforming.

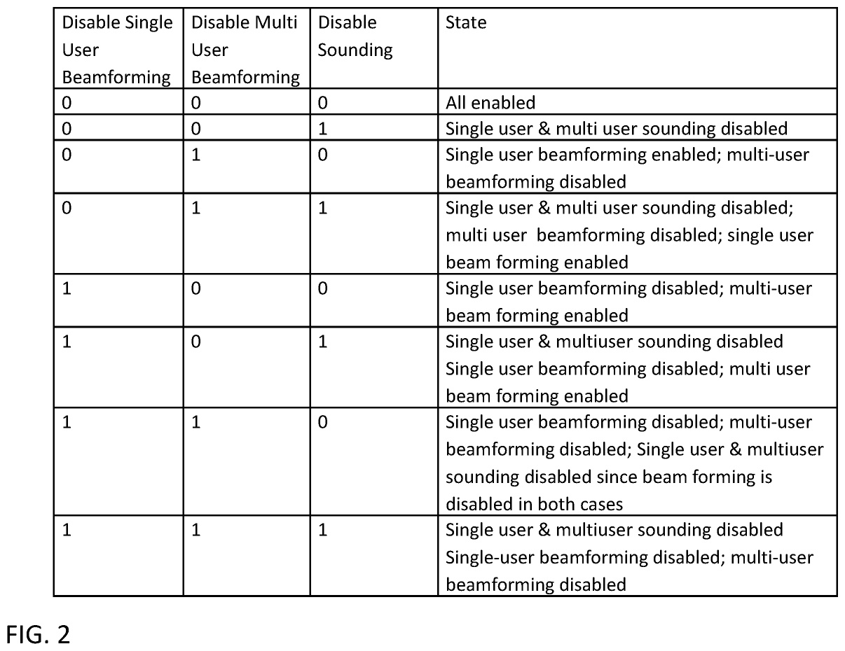

In some embodiments, the instruction includes three bits configured to indicate one of as many as eight states. The indicated states may include various combinations of (i) enabling or disabling single user (SU) beamforming (ii) enabling or disabling multi user (MU) beamforming, and (iii) enabling or disabling sounding. In such an embodiment, capability signaling may be used by the beamformer, as discussed in further detail below. The table of FIG. 2 shows a mapping from eight 3-bit numbers to eight corresponding states (of which the last two are the same), in which the three bits signify that (i) single-user beamforming is disabled, (ii) multi-user beamforming is disabled and (iii) sounding is disabled. Any mapping from three bits to eight states (including the seven distinct states listed in the right hand column of the table of FIG. 2) may be used instead of the mapping illustrated in FIG. 2. As mentioned above, in each of the three embodiments identified above (in which the instruction includes one bit, two bits, or three bits, respectively), capability signaling may be used by the beamformer. This capability signaling may be used by the beamformer to signal (e.g., by the sending of a capability signaling message) to the beamformee that the beamformer is capable of following such an instruction (e.g., an instruction to disable or enable beamforming, or to enable or disable sounding). The capability signaling may be performed, for example, by a capability signaling message that consists of or includes a designated capability signaling bit, which may be a bit in a management frame. The capability signaling bit may be one of a set of physical layer (PHY) capability signaling bits, or it may be one of a set of Media Access Control (MAC) layer capability signaling bits.

The one or more bits used, in the instruction, to encode the enabling or disabling of sounding or beamforming may be transmitted as a part of a frame (e.g., a data frame, a management frame, or a control frame). In some embodiments, the one or more bits are in the header of such a frame.

For example, the one or more bits may be part of a management frame. In such an embodiment, the one or more bits may be in an Operating Mode Notification field, or in an Operating Mode Notification Action frame, or in a new Action frame or in a new Operating Mode Indication frame. As used herein, a “new” frame is any frame not specified in the 802.11 standard.

As another example, the one or more bits may be part of the control information of a frame. In such an embodiment, the frame may be a management frame, or a data frame, or the frame may be part of an Operating Mode Indication.

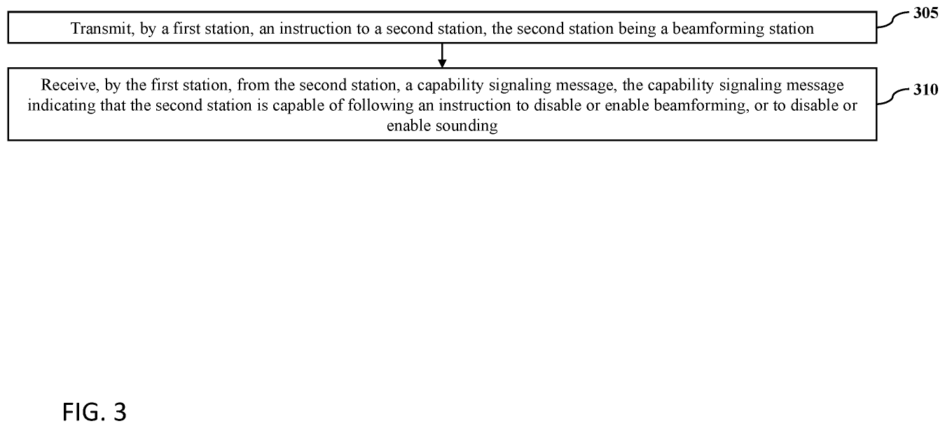

FIG. 3 is a flow chart of a method, in some embodiments. The method includes, transmitting, at 305, by a first station, an instruction to a second station, the second station being a beamforming station, wherein the instruction instructs the second station: to disable or enable beamforming, or to disable or enable sounding. In some embodiments, the instruction instructs the second station to disable sounding. In some embodiments, the instruction further instructs the second station to disable beamforming. In some embodiments, the first station is a non-access-point station. In some embodiments: the instruction includes two bits; and the two bits are configured to indicate one of three states, the three states including: a first state in which beamforming and sounding are both enabled, a second state in which beamforming is enabled and sounding is disabled, and a third state in which beamforming and sounding are both disabled. In some embodiments, the instruction includes a bit, and the bit is in a management frame. In some embodiments, the bit is in an Operating Mode Notification field. In some embodiments, the bit is in an Operating Mode Notification Action frame. In some embodiments, the bit is in a new Action frame or in a new Operating Mode Indication field.

In some embodiments, the instruction includes a bit, and the bit is in control information of a frame. In some embodiments, the frame is a management frame. In some embodiments, the frame is a data frame. In some embodiments, the frame is part of an Operating Mode Indication. In some embodiments, the method further includes receiving, at 310, by the first station, from the second station, a capability signaling message, the capability signaling message indicating that the second station is capable of following an instruction: to disable or enable beamforming, or to disable or enable sounding. In some embodiments, the capability signaling message is a physical layer capability signaling message. In some embodiments, the capability signaling message is a portion of a management frame.

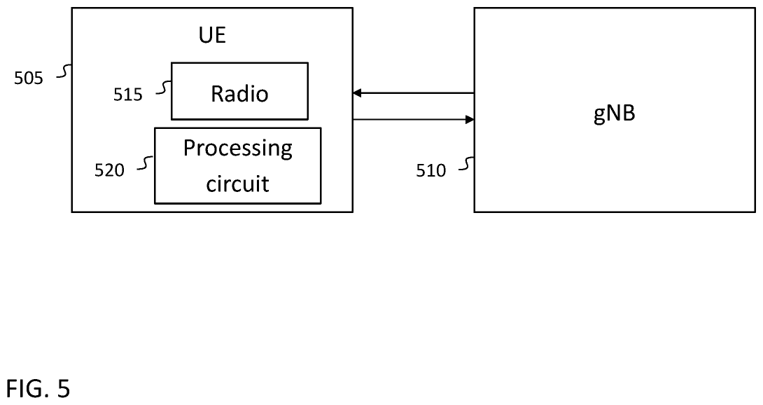

In some embodiments, the non-Access Point Station 105 includes (e.g., is) a User Equipment (UE) 505 (FIG. 5) of a mobile telephone network. For example, the non-Access Point Station 105 may be or include a mobile telephone, or a laptop computer capable of connecting to a mobile telephone network, or a tablet computer capable of connecting to a mobile telephone network.

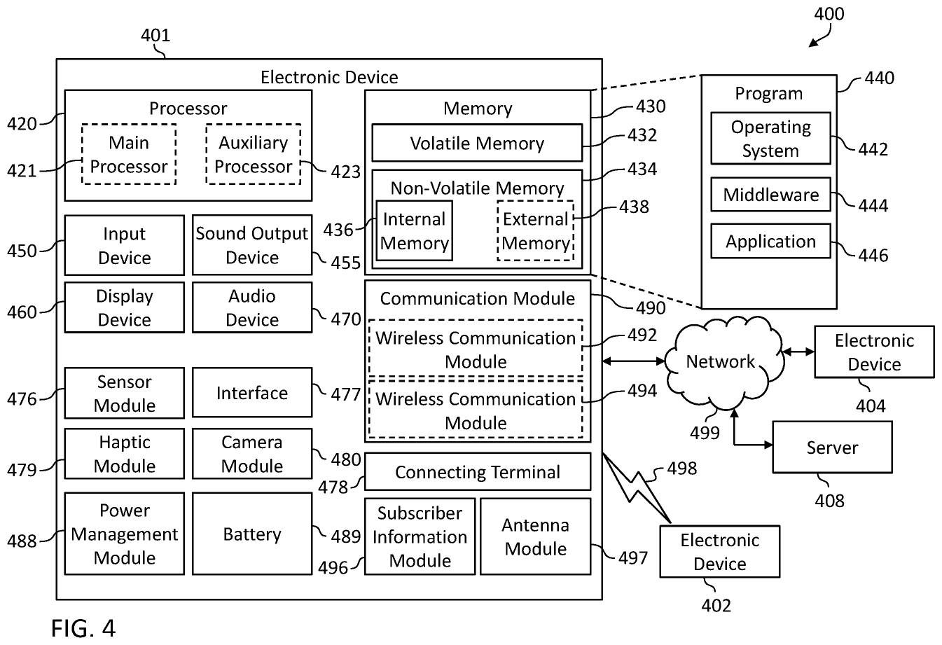

FIG. 4 is a block diagram of an electronic device, which may be or include the non-Access Point Station 105, in a network environment 400, according to an embodiment.

Referring to FIG. 4, an electronic device 401 in a network environment 400 may communicate with an electronic device 402 via a first network 498 (e.g., a short-range wireless communication network), or an electronic device 404 or a server 408 via a second network 499 (e.g., a long-range wireless communication network). The electronic device 401 may communicate with the electronic device 404 via the server 408. The electronic device 401 may include a processor 420, a memory 430, an input device 450, a sound output device 455, a display device 460, an audio module 470, a sensor module 476, an interface 477, a haptic module 479, a camera module 480, a power management module 488, a battery 489, a communication module 490, a subscriber identification module (SIM) card 496, or an antenna module 497. In one embodiment, at least one (e.g., the display device 460 or the camera module 480) of the components may be omitted from the electronic device 401, or one or more other components may be added to the electronic device 401. Some of the components may be implemented as a single integrated circuit (IC). For example, the sensor module 476 (e.g., a fingerprint sensor, an iris sensor, or an illuminance sensor) may be embedded in the display device 460 (e.g., a display).

The processor 420 may execute software (e.g., a program 440) to control at least one other component (e.g., a hardware or a software component) of the electronic device 401 coupled with the processor 420 and may perform various data processing or computations.

As at least part of the data processing or computations, the processor 420 may load a command or data received from another component (e.g., the sensor module 476 or the communication module 490) in volatile memory 432, process the command or the data stored in the volatile memory 432, and store resulting data in non-volatile memory 434. The processor 420 may include a main processor 421 (e.g., a central processing unit (CPU) or an application processor (AP)), and an auxiliary processor 423 (e.g., a graphics processing unit (GPU), an image signal processor (ISP), a sensor hub processor, or a communication processor (CP)) that is operable independently from, or in conjunction with, the main processor 421. Additionally or alternatively, the auxiliary processor 423 may be adapted to consume less power than the main processor 421, or execute a particular function. The auxiliary processor 423 may be implemented as being separate from, or a part of, the main processor 421.

The auxiliary processor 423 may control at least some of the functions or states related to at least one component (e.g., the display device 460, the sensor module 476, or the communication module 490) among the components of the electronic device 401, instead of the main processor 421 while the main processor 421 is in an inactive (e.g., sleep) state, or together with the main processor 421 while the main processor 421 is in an active state (e.g., executing an application). The auxiliary processor 423 (e.g., an image signal processor or a communication processor) may be implemented as part of another component (e.g., the camera module 480 or the communication module 490) functionally related to the auxiliary processor 423.

The memory 430 may store various data used by at least one component (e.g., the processor 420 or the sensor module 476) of the electronic device 401. The various data may include, for example, software (e.g., the program 440) and input data or output data for a command related thereto. The memory 430 may include the volatile memory 432 or the non-volatile memory 434. Non-volatile memory 434 may include internal memory 436 and/or external memory 438.

The program 440 may be stored in the memory 430 as software, and may include, for example, an operating system (OS) 442, middleware 444, or an application 446.

The input device 450 may receive a command or data to be used by another component (e.g., the processor 420) of the electronic device 401, from the outside (e.g., a user) of the electronic device 401. The input device 450 may include, for example, a microphone, a mouse, or a keyboard.

The sound output device 455 may output sound signals to the outside of the electronic device 401. The sound output device 455 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 460 may visually provide information to the outside (e.g., a user) of the electronic device 401. The display device 460 may include, for example, a display, a hologram device, or a projector and control circuitry to control a corresponding one of the display, hologram device, and projector. The display device 460 may include touch circuitry adapted to detect a touch, or sensor circuitry (e.g., a pressure sensor) adapted to measure the intensity of force incurred by the touch.

The audio module 470 may convert a sound into an electrical signal and vice versa. The audio module 470 may obtain the sound via the input device 450 or output the sound via the sound output device 455 or a headphone of an external electronic device 402 directly (e.g., wired) or wirelessly coupled with the electronic device 401.

The sensor module 476 may detect an operational state (e.g., power or temperature) of the electronic device 401 or an environmental state (e.g., a state of a user) external to the electronic device 401, and then generate an electrical signal or data value corresponding to the detected state. The sensor module 476 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 477 may support one or more specified protocols to be used for the electronic device 401 to be coupled with the external electronic device 402 directly (e.g., wired) or wirelessly. The interface 477 may include, for example, a high-definition multimedia interface (HDMI), a universal serial bus (USB) interface, a secure digital (SD) card interface, or an audio interface.

A connecting terminal 478 may include a connector via which the electronic device 401 may be physically connected with the external electronic device 402. The connecting terminal 478 may include, for example, an HDMI connector, a USB connector, an SD card connector, or an audio connector (e.g., a headphone connector).

The haptic module 479 may convert an electrical signal into a mechanical stimulus (e.g., a vibration or a movement) or an electrical stimulus which may be recognized by a user via tactile sensation or kinesthetic sensation. The haptic module 479 may include, for example, a motor, a piezoelectric element, or an electrical stimulator.

The camera module 480 may capture a still image or moving images. The camera module 480 may include one or more lenses, image sensors, image signal processors, or flashes. The power management module 488 may manage power supplied to the electronic device 401. The power management module 488 may be implemented as at least part of, for example, a power management integrated circuit (PMIC).

The battery 489 may supply power to at least one component of the electronic device 401. The battery 489 may include, for example, a primary cell which is not rechargeable, a secondary cell which is rechargeable, or a fuel cell.

The communication module 490 may support establishing a direct (e.g., wired) communication channel or a wireless communication channel between the electronic device 401 and the external electronic device (e.g., the electronic device 402, the electronic device 404, or the server 408) and performing communication via the established communication channel. The communication module 490 may include one or more communication processors that are operable independently from the processor 420 (e.g., the AP) and supports a direct (e.g., wired) communication or a wireless communication. The communication module 490 may include a wireless communication module 492 (e.g., a cellular communication module, a short-range wireless communication module, or a global navigation satellite system (GNSS) communication module) or a wired communication module 494 (e.g., a local area network (LAN) communication module or a power line communication (PLC) module). A corresponding one of these communication modules may communicate with the external electronic device via the first network 498 (e.g., a short-range communication network, such as BLUETOOTH™, wireless-fidelity (Wi-Fi) direct, or a standard of the Infrared Data Association (IrDA)) or the second network 499 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 492 may identify and authenticate the electronic device 401 in a communication network, such as the first network 498 or the second network 499, using subscriber information (e.g., international mobile subscriber identity (IMSI)) stored in the subscriber identification module 496.

The antenna module 497 may transmit or receive a signal or power to or from the outside (e.g., the external electronic device) of the electronic device 401. The antenna module 497 may include one or more antennas, and, therefrom, at least one antenna appropriate for a communication scheme used in the communication network, such as the first network 498 or the second network 499, may be selected, for example, by the communication module 490 (e.g., the wireless communication module 492). The signal or the power may then be transmitted or received between the communication module 490 and the external electronic device via the selected at least one antenna.

Commands or data may be transmitted or received between the electronic device 401 and the external electronic device 404 via the server 408 coupled with the second network 499. Each of the electronic devices 402 and 404 may be a device of a same type as, or a different type, from the electronic device 401. All or some of operations to be executed at the electronic device 401 may be executed at one or more of the external electronic devices 402, 404, or 408. For example, if the electronic device 401 should perform a function or a service automatically, or in response to a request from a user or another device, the electronic device 401, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 401. The electronic device 401 may provide the outcome, with or without further processing of the outcome, as at least part of a reply to the request. To that end, a cloud computing, distributed computing, or client-server computing technology may be used, for example.

FIG. 5 shows a system including a UE 505 and a gNB 510, in communication with each other. The UE may include a radio 515 and a processing circuit (or a means for processing) 520, which may perform various methods disclosed herein, e.g., the method illustrated in FIG. 3. For example, the processing circuit 520 may receive, via the radio 515, transmissions from the network node (gNB) 510, and the processing circuit 520 may transmit, via the radio 515, signals to the gNB 510.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method, comprising:
transmitting, by a first station, an instruction to a second station,
the second station being a beamforming station,
wherein the instruction instructs the second station:
to disable or enable beamforming, or
to disable or enable sounding.

2. The method of claim 1, wherein the instruction instructs the second station to disable sounding.

3. The method of claim 2, wherein the instruction further instructs the second station to disable beamforming.

4. The method of claim 1, wherein the first station is a beamforming station.

5. The method of claim 1, wherein:
the instruction comprises two bits; and
the two bits are configured to indicate one of three states, the three states including:
a first state in which beamforming and sounding are both enabled,
a second state in which beamforming is enabled and sounding is disabled, and
a third state in which beamforming and sounding are both disabled.

6. The method of claim 1, wherein the instruction comprises a bit, and the bit is in a management frame.

7. The method of claim 6, wherein the bit is in an Operating Mode Indication field.

8. The method of claim 6, wherein the bit is in an Operating Mode Notification Action frame.

9. The method of claim 6, wherein the bit is in a new Action frame or in a new Operating Mode Indication frame.

10. The method of claim 1, wherein the instruction comprises a bit, and the bit is in control information of a frame.

11. The method of claim 10, wherein the frame is a management frame.

12. The method of claim 10, wherein the frame is a data frame.

13. The method of claim 10, wherein the frame is part of an Operating Mode Indication.

14. The method of claim 1, further comprising receiving, by the first station, from the second station, a capability signaling message, the capability signaling message indicating that the second station is capable of following an instruction:
to disable or enable beamforming, or
to disable or enable sounding.

15. The method of claim 14, wherein the capability signaling message is a physical layer capability signaling message.

16. The method of claim 14, wherein the capability signaling message is a portion of a management frame.

17. A device, comprising:
a radio;
one or more processors; and
a memory storing instructions which, when executed by the one or more processors, cause performance of transmitting, by the radio, an instruction to a first station, the first station being a beamforming station,
wherein the instruction instructs the first station:
to disable or enable beamforming, or
to enable or disable sounding.

18. The method of claim 17, wherein the instruction instructs the first station to disable sounding.

19. The method of claim 18, wherein the device comprises a non-Access Point Station.

20. A device, comprising:
a radio;
means for processing; and
a memory storing instructions which, when executed by the means for processing, cause performance of transmitting, by the radio, an instruction to a first station, the first station being a beamforming station,
wherein the instruction instructs the first station:
to disable or enable beamforming, or
to disable or enable sounding.
